(19) United States
(12) Patent Application Publication
(10) Pub. No.: US 2009/0063786 A1
(43) Pub. Date: Mar. 5, 2009

(54) Daisy-chain memory configuration and usage

(76) Inventor: HakJune Oh, Kanata (CA)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 11/897,105

(22) Filed: Aug. 29, 2007

(51) Int. Cl. G06F 12/00

(52) U.S. Cl. 711/148; 711/E12.002

(57) ABSTRACT

Daisy-chain memory configuration and usage is disclosed. According to one configuration, a memory system includes a controller and corresponding string of multiple successive memory devices coupled in a daisy-chain manner. The controller communicates commands over the serial control link to configure a first memory device to write a block of data to a second memory device in the chain. For example, the controller initiates copying a block of data by communicating over the daisy-chain control link to configure a first memory device of the multiple memory devices to be a source for outputting data, communicating over the daisy-chain control link to configure a second memory device to be a destination for receiving data, and communicating over the daisy-chain control link to initiate a transfer of the data from the first memory device to the second memory device.

### RELATED APPLICATIONS

This application is related to earlier filed U.S. Provisional Patent Application Ser. No. 60/902,003 entitled “NON-VOLATILE MEMORY SYSTEM,” [Attorney Docket No. MOS07-01(1245-01US-0PR)p], filed on Feb. 16, 2007, the entire teachings of which are incorporated herein by this reference.

### BACKGROUND

Today, many electronic devices include memory systems to store information. For example, some memory systems store digitized audio information for playback by a respective media player. Other memory systems store software and related information to carry out different types of processing functions.

In many of the electronic devices, the memory systems often comprise a controller and one or more corresponding memory devices. The controller typically includes circuitry configured to generate signals to the memory devices for storage and retrieval of data.

In certain conventional memory systems, a controller such as a processor uses an address bus and data bus to access data stored in memory. Often, many wires are used to implement such buses and, depending on the layout of the memory system, bus connections may extend for long distances and pass through many different circuit board layers because of the need to directly connect the processor to each of many different memory devices.

### BRIEF DESCRIPTION OF THE DRAWINGS

Reference will now be made, by way of example, to the accompanying drawings of which:

FIGS. 1A and 1B are example block diagrams of a memory system according to embodiments herein;

FIG. 2 is an example block diagram of a memory system according to first embodiments herein;

FIG. 3 is an example timing diagram for carrying out a block copy according to embodiments herein;

FIG. 4 is an example flowchart describing a sequence of steps executed by a memory controller to copy data from one memory device to another according to embodiments herein;

FIG. 5 is an example block diagram of a memory system according to second embodiments herein;

FIG. 6A is a block diagram illustrating an example memory system and copying of data from one memory device to multiple memory devices according to embodiments herein;

FIG. 6B is an example flowchart describing a sequence of steps executed by a memory controller to copy data from one memory device to multiple memory devices according to embodiments herein;

FIGS. 7-10 are example timing diagrams illustrating packet timing information according to embodiments herein;

FIG. 11 is an example architecture of a controller according to embodiments herein; and

FIG. 12 is an example flowchart illustrating a method of copying of data according to embodiments herein.

### DETAILED DESCRIPTION OF ILLUSTRATED EMBODIMENTS

There are certain disadvantages associated with conventional parallel bus implementations to access data stored in memory. One disadvantage relates to the complexity involved in implementing such systems. For example, circuit and trace layout can be challenging because conventional parallel buses often require many connections through many printed circuit board layers.

Another disadvantage of parallel buses relates to signal quality in the memory system. For example, parallel buses tend to be susceptible to crosstalk, signal skew, signal attenuation and noise, which may affect the quality of the signals carried by the connections.

Yet another disadvantage associated with parallel bus designs relates to power consumption. For example, parallel buses tend to require a significant amount of power in order to drive the signals onto the bus. Power consumption typically worsens for new technology that operates at yet higher and higher access speeds.

To address shortcomings associated with parallel buses, some memory systems incorporate conventional serial bus designs for transferring data and control signals between a controller and respective memory devices. Conventional serial bus designs tend to utilize fewer connections (because the data is transmitted serially rather than in parallel) and thus are not as complex and as susceptible to layout problems associated with parallel bus designs.

Conventional memory systems as discussed above can be used to support data transfers from one memory device to another. For example, assume that a memory controller in a conventional memory system receives a command to copy a block of data stored in a first memory device to a second memory device. To carry out such an operation, the controller first accesses the source memory device to retrieve the block of data to be copied. Thereafter, the controller then temporarily stores the accessed data in its local buffer. The controller then initiates a write of the data in the buffer to the target memory device. Even if the memory system happens to be configured with one or more serial buses to alleviate printed circuit board layout problems as mentioned above, this conventional technique of copying data is quite slow because the data has to be retrieved from a memory device, stored locally in the controller's buffer, and transmitted over a bus from the controller to the target memory device for storage of the data in the target memory device. In addition to being slow, the controller in this example must be configured with a buffer large enough to temporarily store the accessed data to be copied to memory. Thus, conventional data transfers can require excess time and storage resources to carry out respective transactions.

In general, certain embodiments herein include a memory system that overcomes the deficiencies as discussed above and/or other deficiencies known in the art. For example, one embodiment herein includes a memory system including a controller and corresponding string of multiple successive memory devices coupled in a daisy-chain manner. In such an embodiment, the memory system includes a serial (daisy-chain) data link and/or serial (daisy-chain) control link from the controller through each of the memory devices (e.g., flash-based memory devices). The controller communicates commands over the serial control link and/or the serial data link to configure the memory system to enable a transfer or copy of data directly from a source memory device to a target memory device in the daisy-chain.

Copying a block of data according to embodiments herein can include multiple steps. For example, the controller can communicate over a daisy-chain link (e.g., serial link) that passes through the multiple successive memory devices to configure a first memory device of the multiple memory devices to be a source for outputting data stored in the first memory device. The controller also communicates over the daisy-chain link to configure a second memory device to be a destination for receiving data. After configuring the first memory device to be a source and configuring the second memory device to be a destination, the controller communicates over the daisy-chain control link with one or more additional commands to initiate a transfer of the data over the daisy-chain link from the source memory device to the target memory device.

A transfer of the copied block data from the source memory device to the target memory device according to embodiments herein alleviates the controller from having to temporarily store the data and transfer it to the destination memory device. As discussed above conventional methods require the controller to retrieve and store the data locally to perform a copy operation. Thus, block copy commands according to embodiments herein can be achieved in less time than over conventional methods. Additionally, a controller according to embodiments herein need not be configured to include a large buffer to temporarily store the block of data being copied because the data is not temporarily stored in the controller as is the case for conventional methods. In other words, the data copied from one memory device can be transferred on a daisy-chain link to another memory device without necessarily passing through the controller.

In addition to supporting point-to-point (e.g., memory chip to memory chip) data transfers, as will be discussed in more detail later in this specification, a controller according to embodiments herein can initiate a block copy of data in one memory device to multiple different memory devices in the daisy-chain. For example, the controller can initiate copying of the same block of data to multiple different memory devices.

In yet other embodiments, the controller can also initiate copying portions of data stored in one memory device to each of multiple memory devices. For example, the controller can initiate communications over a daisy-chain control link to configure a first memory device to be a source having a block of data to be copied, a second memory device to be a target for receiving a first portion of the block of data, a third memory device to be a target for receiving a second portion of the block of data, and so on. After configuration and issuance of additional commands, the controller transfers portions of the block of data from one memory device to the multiple memory devices. Thus, a block of data stored in a single memory device can be copied and distributed to multiple memory devices.

In yet further embodiments, the controller can be configured to include an error detection circuit disposed in the daisy-chain path for checking whether a target memory device (in which data is to be copied) properly receives the data from a source memory device prior to writing of the data to core memory in the target device. If necessary, the controller (e.g., error correction circuit) modifies or repairs the data so that the data written to memory of the target device is error-free.

These and other embodiments will be discussed in more detail later in this specification.

As discussed above, techniques herein are well suited for use in memory systems such as those supporting use of flash technology. However, it should be noted that embodiments herein are not limited to use in such applications and that the techniques discussed herein are well suited for other applications as well.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

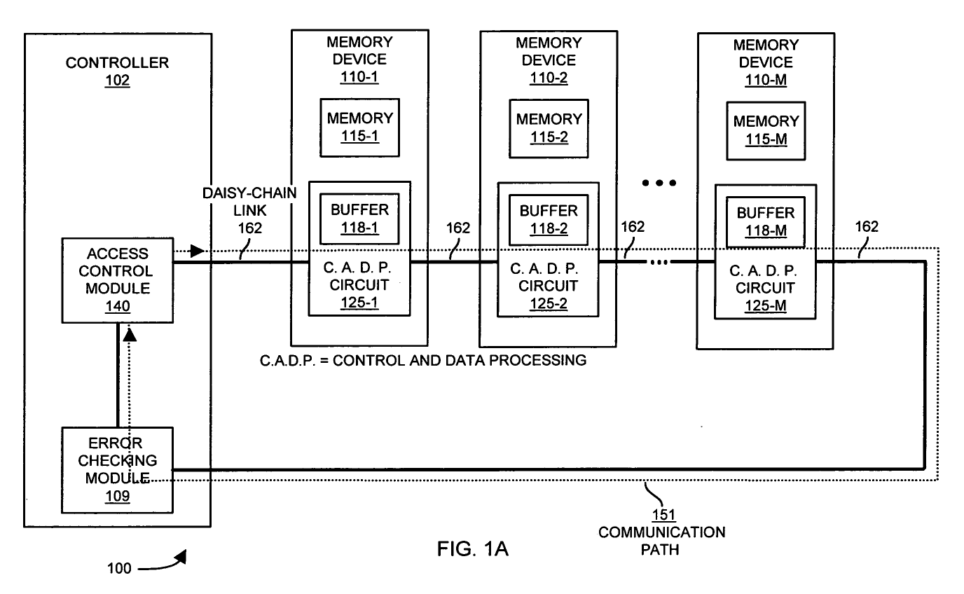

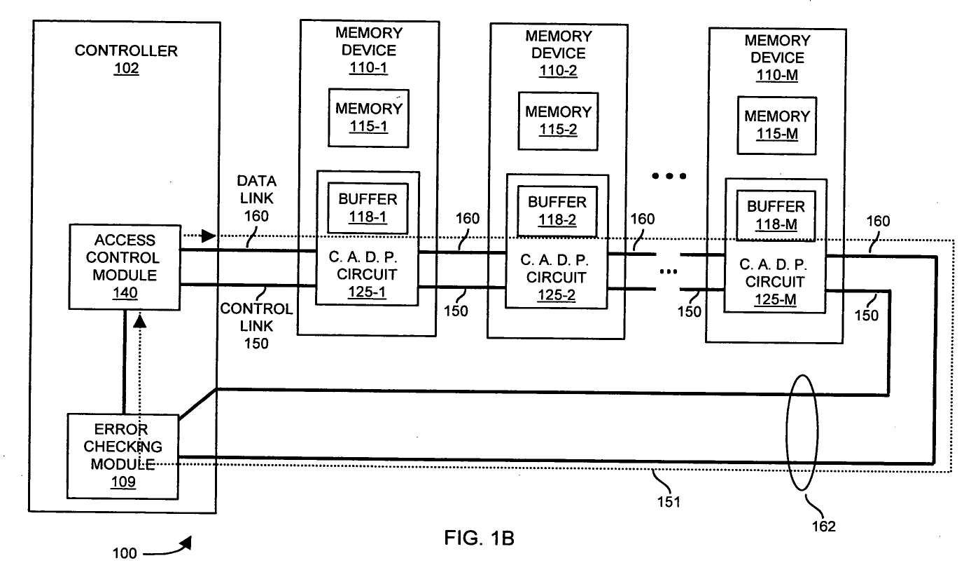

Now, more particularly, FIGS. 1A and 1B illustrate an example memory system 100 according to embodiments herein. In the context of the present example of FIG. 1A, memory system 100 includes controller 102 that accesses multiple memory devices 110 (e.g., memory device 110-1, memory device 110-2, . . . , memory device 110-M) through a serial or daisy chain communication link 162 (e.g., communication path 151). As shown in FIG. 1B, daisy-chain link 162 can include a data link 160 and control link 150. In one embodiment, the data link 160 and control link 150 are logical representations of resources supporting block copying according to embodiments herein. As discussed later in this specification, the functionality associated with data link 160 and control link 150 can be achieved via use of multiple electronic signals forming a daisy-chain path from the controller 102 to and through the memory devices 110. The data link and control link also can depict physical links passing through the string of memory devices 110.

Use of the serial communication links enables operations such as copying of data amongst each node (e.g., controller 102, memory device 110-1, memory device 110-2, etc.) in the memory system 100.

In one embodiment, the daisy-chain link connecting memory devices 110 is closed loop. For example, as shown in FIG. 1B, the control and/or data link passes through each of memory devices 110 back to the controller 102.

Controller 102 includes access control module 140 (e.g., an electronic circuit that supports access control functions as well as other processing functions) and error checking module 109. Access control module 140 associated with controller 102 generates, communicates, and initiates execution of different memory commands or memory operations. As its name suggests, the error checking module 109 supports functions such as error checking and error correction as will be discussed further below.

As shown, each of the memory devices 110 (e.g., flash-based memory devices) can include corresponding (core) memory 115 to store data. Additionally, each of the memory devices 110 can include an interface circuit and corresponding buffer for carrying out memory transactions as specified by the controller 102. For example, memory device 110-1 includes memory 115-1 (e.g., core memory) as well as control and data processing (C.A.D.P.) circuit 125-1 and corresponding buffer 118-1 (e.g., a temporary storage resource); memory device 110-2 includes memory 115-2 as well as control and data processing circuit 125-2 and corresponding buffer 118-2; memory device 110-M includes memory 115-M as well as control and data processing circuit 125-M and corresponding buffer 118-M. The buffers 118-1, 118-2, . . . , 118-M, can be used to temporarily store data retrieved from memory or temporarily store data to be written to memory 115.

Additional details of an example architecture associated with memory devices 110 can be found in U.S. patent application Ser. No. 11/779,587 entitled “MEMORY WITH DATA CONTROL,” (Attorney Docket No. MOS07-02(1255)), filed on Jul. 18, 2007, the entire teachings of which are incorporated herein by this reference.

Note that memory system 100 or, more specifically, memory devices 110 can be implemented using different types of memory. For example, the concepts described herein can be applied to many different types of memory systems and devices including but not limited to flash technology such as NAND flash memory, NOR flash memory, AND flash memory, serial flash memory, Divided Bit-line NOR (DiNOR) flash memory, Dynamic Random Access Memory (DRAM), Static RAM (SRAM), Ferro-electric RAM (FRAM), Magnetic RAM (MRAM), Phase Change RAM (PCRAM), Read Only Memory (ROM), Electrically Erasable Programmable ROM (EEPROM), and the so on.

As mentioned, daisy-chain link 162 provides a path on which the controller 102 communicates information such as configuration information, instructions, commands, etc. to the different memory devices 110. Control link 150 can include a command strobe signal(s) and a data strobe signal(s) as will be discussed later in this specification.

Note that daisy-chain link 162 also can be configured to provide a path on which the memory devices 110 communicate with each other and/or the controller 102.

Data link 160 provides a path on which the controller 102 and/or the memory devices 110 can communicate data amongst each other.

As previously discussed, certain embodiments herein are based on a memory system 100 that overcomes the deficiencies as discussed above and/or other deficiencies known in the art. For example, memory system 100 can include a controller 102 and corresponding string of multiple successive memory devices 110 coupled in a daisy-chain manner to carry out execution of copy or memory transfer commands. During a copy operation, the controller 102 communicates over the daisy-chain link 162 to configure the memory devices 110 for copying of data from one memory device 110 to another.

Communication links such as control link 150 and data link 160 each can include multiple point-to-point segments connecting the nodes in memory system 100. For example, a first segment of control link 150 can be a point-to-point connection between access control module 140 and control and data processing circuit 125-1, a second segment of control link 150 can be a point-to-point connection between control and data processing circuit 125-1 and control and data processing circuit 125-2, . . . , an M+1^{th} segment of control link 150 can be a point-to-point connection between control and data processing circuit 125-M and controller 102 to close the loop.

Each memory device 110 can include a control and data processing circuit 125 to decode received commands and initiate execution of commands addressed to a respective memory device. Additionally, each control and data processing circuit 125 can pass the received commands and/or data onto a successive downstream device. For example, control and data processing circuit 125-1 can receive a communication from controller 102 on a point-to-point segment of serial link between controller 102 and memory device 110-1 as well as retransmit the received communication down the serial path 151 on a point-to-point segment between control and data processing circuit 125-1 and control and data processing circuit 125-2. The other memory devices can operate in a similar way such that the access control module 140 can communicate (e.g., send and receive information) with any of the memory devices 110.

Note that the controller 102 can configure each of the memory devices 110 in accordance with a pass-through or non-pass-through mode. In the pass-through mode, a respective memory device receives input from an upstream device (e.g., controller 102 or memory device) and passes the received input to a downstream node (e.g., a memory device such as memory device 110-2, . . . , memory device 110-M).

Assume that the controller 102 communicates a command (downstream) over the daisy-chain link to an input of a first memory device such as memory device 110-1. When in the pass-through mode, memory device 110-1, in turn, outputs the command to an input of a downstream memory device in the daisy-chain such as memory device 110-2. When each node in memory system 100 is configured to be in the pass-through mode, the controller 102 can transmit a command that traverses path 151 all the way back to the controller 102. While in such a mode, the memory devices 110 can transmit messages and/or data that traverses path 151 back to the controller 110. Configuring memory devices in memory device 100 to the pass-through mode increases power consumption because each memory device must spend power driving inputs of a following memory device in the daisy-chain link. However, the pass-through mode enables the controller 102 to perform functions such as receive data for error checking as will be discussed in more detail below.

In the non-pass-through mode, a respective memory device receives input from an upstream device (e.g., controller 102 or other memory device) and prevents passing or transmission of the received input to a downstream node (e.g., another memory device). One purpose to configure one or more nodes in memory system 100 to a non-pass-through mode is to decrease power consumption.

In one embodiment, the data transfer (e.g., block copy) of data from one memory device to another occurs without the controller 102 having to retrieve and store the data locally and, thereafter, write the data to a target memory device. Instead, according to one embodiment herein, the controller 102 communicates over the control link 150 and data link 160 to configure the memory devices to perform a retrieval (e.g., read) of data from a source memory 115-1 into buffer 118-1, transfer of the data from the buffer 118-1 of the source memory device to a buffer 118-M of a target memory device 110-M, and storage (e.g., write) of the transferred data in buffer 118-M to core memory 115-M of the target device 110-M. Thus, embodiments herein include a controller 102 configured to communicate over a daisy-chain control link to configure each of multiple selected memory devices 110 and initiate transmission of data on a serial or daisy-chain data link that passes through the multiple successive memory devices from memory device 110-1, through an intermediary memory device such as memory device 110-2, to memory device 110-M.

Accordingly, one embodiment herein includes one or more memory devices, each of which is configured to include an input for receiving data from an upstream memory device; an output for transmitting data to a downstream memory device; and a control and data processing circuit 125 between the input and the output. The control and data processing circuit 125 is configured to receive configuration commands from a remote source such as controller 102 and, based on selection of a corresponding mode by the remote source, retrieve the data stored in corresponding memory 115 for transmission on the memory device's output to a downstream memory device as specified by the controller 102.

As mentioned, the memory devices 110 can be flash-based memory devices and the buffers 118 can store a page of information (e.g., 8 kilobytes of data) at a time to carry out a block copy operation of multiple pages of data. Thus, a block copy can entail transferring one or more pages of information in one memory device to one or more other memory devices in the daisy-chain.

As a more specific example illustrating copying or moving of data, assume that the controller 102 receives a request from a source (e.g., a user, computer system, etc.) to carry out an operation such as copying a block of data (e.g., one or multiple bits or pages of data) from memory device 110-1 (e.g., a source) to memory device 110-M (e.g., a target). In such an instance, the controller 102 first communicates over the control link 150 and data link 160 (e.g., a daisy-chain link that passes through the multiple successive memory devices 110) to configure the memory devices for such an operation. As mentioned above, this can include creating and then transmitting a first message on the control link 150 and data link 160 to configure memory device 110-1 to be a source, creating and then transmitting a second message on the control link 150 and data link 160 to configure memory device 110-M to be a target, and creating and then transmitting additional messages on the control link 150 and data link 160 to initiate a transfer of the data from memory device 110-1 to memory device 110-M.

Additional instructions communicated on control link 150 and data link 160 to the memory devices 110 indicate more intricate details associated with a transaction. For example, the controller 102 can communicate with the target memory device to specify from which location to retrieved data and how large a block copy to perform. The controller 102 can also communicate with the target memory device to specify which location (or locations) of the target memory device (or target memory devices) in which to store corresponding data.

Although the present example discusses a data transfer from a source memory device, through an intermediary memory device, to a target memory device, embodiments herein enable any of the memory devices to copy data to other memory devices in the memory system 100. For example, the controller 102 can configure memory device 110-M to be source and memory device 110-1 to be a target for receiving and storing the data. In such an embodiment, during a transfer, the controller 102 receives and passes the data from memory device 110-M to memory device 110-1. Thus, use of the daisy-chain control link 150 and data link 160 enable each memory device to transfer data to any other memory device in the daisy-chain.

In one embodiment, to carry out communications, each of the memory devices 110 is assigned a unique address value. The controller 102 transmits the messages (e.g., commands or instructions) with corresponding address information so that, if the message is received by all memory devices 110 as transmitted over control link 150 and data link 160, the memory device to which the message (e.g., command) is addressed receives and executes the command.

Thus, based on issuing commands addressed to the memory devices 110, the memory system 100 enables a transfer and direct copying of data from a first memory device to a second memory device. This alleviates the controller 102 from having to temporarily retrieve and store from a first memory device in the sequence of memory devices and transfer it to a destination memory device in the sequence. Thus, block copy commands can be achieved in less time than over conventional methods, which require the controller 102 to access and locally store the data.

Note also that the controller 102 according to certain embodiments herein need not be configured to include a large buffer to temporarily store the block of copied data because the data need not be temporarily stored in the controller as is the case for conventional methods. However, the controller 102 may include at least a buffer to aid in an error checking process as further discussed below.

In yet further embodiments, the controller 102 can also initiate copying and/or distributing different portions of data stored in one memory device to each of multiple different memory devices. For example, the controller 102 can initiate communications over the daisy-chain control link 150 and data link 160 to configure a first memory device to be a source having a block of data to be copied, a second memory device to be a target for receiving a first portion of the block of data, a third memory device to be a target for receiving a second portion of the block of data, yet another memory device 110-2 to be a target for receiving a third portion of the block of data, and so on. Thus, via one or more configuration instructions and commands, the controller 102 can transfer portions of a block of data from one memory device to multiple memory devices. In other words, portions of data stored in a single memory device can be distributed and copied to multiple memory devices based on the controller 102: communicating over the daisy-chain link to initiate storage of the first portion of the data from the source memory device to a memory location in the second memory device, and communicating over the daisy-chain link to initiate storage of a second portion of the data from the source memory device to a memory location in the third memory device, and so on.

In yet further embodiments, as briefly mentioned above, the controller 102 can be configured to include an error-checking module 109 (e.g., an error detection circuit). The error-checking module 109 can be disposed in the daisy-chain path 151 for checking whether a target memory device (in which data is to be copied) properly receives the data from a source memory device prior to writing the data to memory in the target device. If necessary, the controller (e.g., error correction circuit) modifies or repairs the data so that the data written to memory of the target device is error-free.

As an example, assume that controller 102 initiates a copy of data from memory device 110-1 to memory device 110-M as discussed above. When receiving a transfer of data from buffer 118-1, memory device 110-M stores the data in buffer 118-M as well as passes the data on data link 160 to the error-checking module 109 of controller 102. When in the pass-through mode, data link 160 can be a data bus for simultaneously transferring multiple bits of data from memory device 110-1, to and through memory device 110-M, to error checking module 109. The data received by the error-checking module 109 should be the same as the data received by memory device 110-M and stored in buffer 118-M. By applying an error-checking algorithm, the error-checking module 109 can detect errors associated with data in the buffer 118-M and, in such an instance, prevent writing of the data in buffer 118-M to memory 115-M. Thus, embodiments herein can include passing a ‘Write Data Packet’ (e.g., block copy data) down the daisy-chain so that the controller 102 can perform ECC operations to check whether the data packet transmitted from one memory device to another contains errors.

In one embodiment, the error-checking module 109 implements an algorithm to detect which bits in the buffer need to be corrected. Prior to initiating a transfer (e.g., a write) of the data in buffer 118-M to memory 115-M, assuming that the error-checking module 109 detects an error, the controller 102 communicates over the control link and data link to correct the error by modifying contents of the buffer 118-M.

Memory system 100 and/or memory devices 110 (e.g., flash memory devices) can be used in different types of electronic systems such as in mobile communication devices, game sets, cameras, and so on. Memory system 100 can be implemented as either removable memory cards that can be inserted into multiple host systems or as non-removable embedded storage within the host systems.

Memory 115 in corresponding memory device 110 can be composed of one or more arrays of transistor cells, each cell capable of non-volatile or volatile storage of one or more bits of data. Depending on the embodiment, such memory may or may not require power to retain the data programmed therein.

If memory 115 is flash based memory, a cell (e.g., a data storage location) may need to be erased before it can be reprogrammed with a new data value. As mentioned above, the controller 102 can communicate with and through memory devices 110 to carry out such erase functions.

Memory 115 in corresponding memory devices 110 can include arrays of cells partitioned into groups to provide for efficient execution of read, program, and erase functions. Groups of cells or so-called blocks can be further partitioned into one or more addressable sectors that are the basic units for read and program functions.

When writing data in a flash device, a single batch of data is typically written in one block because of the simplicity in data management. This makes a free area in one block fairly large, resulting in ineffective use of a data area. Therefore, when a NAND flash memory is used, data of one page in a certain block can be read out from the data that has once been written, and the read data is temporarily latched by a sense/latch circuit. The data latched by the sense/latch circuit is then written into a page of the free area in a block that is different from the block where the data was read out. Such an operation is called page copying, which enables effective use of memory space.

As mentioned above, memories 115 can support page copy operations (e.g., copy-back operations). A page copy operation involves transcribing data stored at an address of a first page to a specified address of a second page. During the page copy, data stored in a page (i.e., a source page) of a source memory device are transferred to a page buffer. The data stored in the page buffer is then transferred to a buffer of another memory device in the daisy-chain or serial link for writing. As mentioned above, this can be achieved without storing the data in the controller 102. Effectively, the data can be copied without the controller 102 reading the data out of the flash memory. As discussed above, since flash devices do not support direct “over-writing” functions, a target page location of memory system 100 may need to be erased prior to writing new data to a target memory location.

Contents of cells or locations associated with memory devices may be modified only a limited number of times because they can withstand only a limited number of P/E (Program/Erase) cycles. A so-called P/E cycle limitation may be more severe in MLC (Multi-Level-Cell) type NAND flash memories than in SLC (Single Level-Cell). For example, SLC memory devices can be reliable up to 100,000 P/E cycles for the life of the device, whereas MLC NAND flash memory device typically can withstand only around 10,000 P/E cycles. However, because of the advantage of the cost effective density in MLC NAND flash devices (e.g., MLC devices are two times bigger than SLC in terms of density), more manufacturers have been producing MLC NAND flash memories these days.

One way to extend the life and reduce “burning out” locations or cells of a corresponding memory device 110 is to distribute writing of data to different locations over time. Writing of data to different locations maintains even wearing of the flash memory device. When using MLC flash devices in memory system 100, compared to using SLC flash devices, more care can be taken during the store process because such devices do not support the higher P/E cycles.

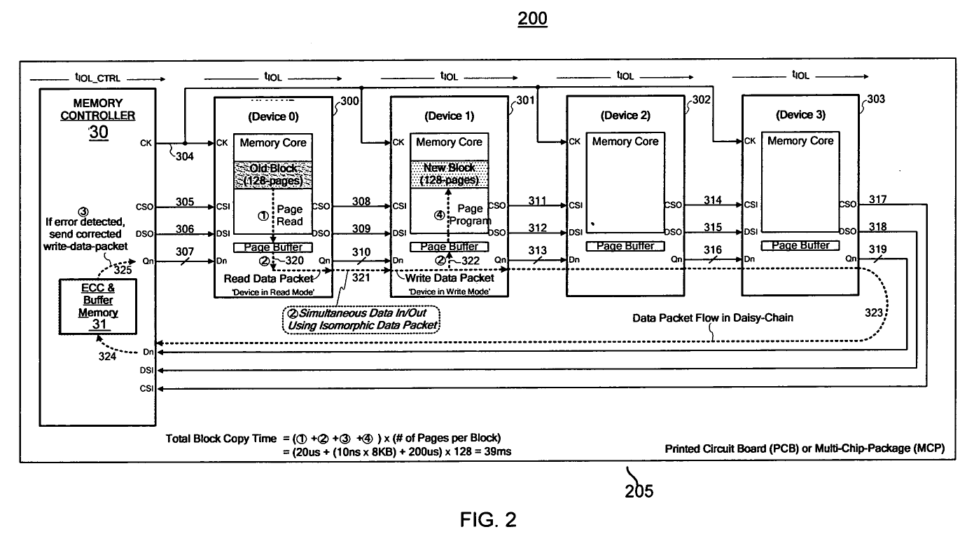

FIG. 2 is a block diagram of an example memory system 200 illustrating copying of data according to embodiments herein.

In general, memory system 200 supports faster block copying than conventional methods. For example, memory system 200 implements a serialized high speed link (e.g., a daisy-chained data link path 323) of input/output pins (e.g., Dn is a Serial Data Input Port for receiving data, Qn is a Serial Data Output Port for outputting data) to carry out block copy operations. As an example data flow, the controller 30 and/or the memory devices can output data onto the data link Qn in order to transmit data to an input (e.g., Dn) of a next successive downstream device. As described herein, the device receiving the data on input Dn can be configured to process the received data (e.g., store the data in its local page buffer) and/or output the data on its corresponding Qn output.

Signals Dn and Qn can be one or more data bits wide, enabling the controller 30 and respective memory devices to simultaneously communicate multiple data bits in downstream manner to other memory devices.

As shown, memory controller 30 outputs CSO (e.g., command strobe output), DSO (e.g., data strobe output) and Qn signals on respective interconnections 305, 306, and 307 to memory device 300. Memory device 300 in turn produces and outputs its corresponding CSO, DSO, and Qn signals on respective interconnections 308, 309, and 310 to memory device 301. Memory device 301 in turn produces and outputs its corresponding CSO, DSO, and Qn signals on respective interconnections 311, 312, and 313 to memory device 302. Memory device 302 in turn produces and outputs its corresponding CSO, DSO, and Qn signals on respective interconnections 314, 315, and 316 to memory device 303. Completing the daisy-chain loop back to the controller 30, memory device 303 in turn produces and outputs its corresponding CSO, DSO, and Qn signals on respective interconnections 317, 318, and 319 to controller 30.

As described herein, this sequence of interconnections produces a daisy-chain flow path 323 on which to transmit data packets and control signals from device to device such as from controller 30 to a respective memory device, from a first memory device to a second memory device in the daisy-chain, or from a memory device to the controller 30.

Note that the CSI and/or DSI signals can be active high or active low depending on the embodiment.

In the example embodiment shown, the controller 30 outputs a clock signal (e.g., based on a SDR/DDR/QDR clock in the controller) that drives each of the memory devices in the daisy-chain. Use of the clock enables synchronous data transfers amongst the devices. Note that the clock can be implemented as a differential signal or a single-ended signal.

Memory system 200 also includes a control link. The control link in the present example includes two dedicated control signals: i) a command strobe input, CSI, for communicating command/address packets (e.g., commands) from controller 30 to the memory devices, and ii) a data strobe signal, DSI, for initiating writing & reading of data packets (e.g., copied data) amongst the memory devices. Thus, signals CSI and/or DSI as generated by the controller 30 (and as passed downstream to other devices on the daisy-chain) enable and disable a transfer of command/address packets and data packets respectively. In a similar vein as embodiments discussed above for FIG. 1B, control of the command strobe (CS) signals and the data strobe (DS) signals by controller 30 in FIG. 2 enable transmission of the packets and execution of block copying operations amongst nodes (e.g., memory devices) in the serially connected daisy-chain of memory devices.

Thus, memory system 200 can be considered a packet oriented memory system supporting generation and distribution of three types of packets: “Command and Address Packets (=CAP)”, “Write Data Packets(=WDP)” and “Read Data Packets(=RDP)” to carry out copying and related functions as discussed below.

“Command and Address Packets” as generated by the controller 202 contain command and address information transmitted over the serial link to the memory devices 300, 301, 302, and 303. As shown, “Command and Address Packets” arrive at the memory devices through the serial data input port(s), Dn, and are output on ports Qn. The endpoints of the Command and Address Packets can coincide with edges of the command strobe signal, CSI (=Command Strobe Input).

“Write Data Packets” (e.g., data being written, data being copied, transferred data, data correction information, etc.) arrive at the respective memory devices through the serial data input port(s), Dn, and are delimited by strobe signal, DSI (=Data Strobe Input).

“Read Data Packets” contain read data output by a respective memory device transmitted on the serial links to the memory controller 202. “Read Data Packets” are output from the memory devices through respective serial data output port(s), Qn, and are delimited by a strobe signal, DSI (=Data Strobe Input).

In one embodiment, each of the “Command and Address Packets”, “Write Data Packets” and “Read Data Packets” is an integral number of bytes long, regardless of the current I/O width (1-bit, 2-bit, 4-bit, etc. wide) associated with Qn.

In one embodiment, the page buffer is 8 kilobytes wide. The interconnections 307, 310, 313, 316, etc. are 4 bits wide. Transferring a page of data requires multiple parallel transfers of data on the daisy-chain from memory device 300 to memory device 301.

Note that memory data transfers can be specified by a start address (e.g., location where data is stored in a memory device) and a transfer length (e.g., an amount of data to be copied). The duration of the corresponding strobe signal (=DSI) from its rising edge to its falling edge depends on the transfer length.

As mentioned above, the proposed memory devices in memory system 200 receive “packetized” command and address information through Dn port(s) when the CSI signal is set to ‘High’ logic state (e.g., CSI is activated). The devices receive/transmit the input/output data packets through Dn/Qn port(s) when DSI is set to a ‘High’ logic state (e.g., DSI is activated). When the CSI signal is activated (i.e., set to a high logic state) referenced at transition edges of clock signals (CK/CK#), the memory device starts to receive (through Dn port(s)) consecutive bytes comprising a Command & Address packet. A command in the “Command & Address packet” specifies an instruction to be executed. The address information in the “Command & Address packet” can also specify memory address location information in which to store and/or retrieve information from a respective memory device.

If the CSI signal is de-activated (e.g., set to a ‘Low’ state), the memory device stops to receive command & address packet through Dn port(s). Similarly when the DSI signal is activated or asserted (e.g., DSI is set a ‘High’ state) while a memory device is in write mode, the memory device starts to receive, through Dn port(s), a ‘write-data packet’ referenced at transition edges of clock signals (CK/CK#). If the DSI signal is deactivated or de-asserted (i.e., DSI is set to a ‘Low’ state), the memory device stops to receive ‘write data packet’ through Dn port(s).

When the DSI signal is activated or asserted (e.g., set to a ‘High’ state) while a memory device is in read mode, the memory device in the read mode starts to transmit the ‘read-data packet’ through Qn port(s). When the DSI signal is de-asserted or deactivated (e.g., DSI is set to a ‘Low’ state), the memory device in the read mode stops transmitting ‘read-data packet’ through Qn port(s).

As shown in FIG. 2, the memory controller 30 can include an ‘ECC & Buffer Memory’ block 31 that provides error detector and/or correction functionality. The serial connection (e.g., daisy-chain of one or more data and/or control link) through the memory devices form a feedback loop back to the controller 30. Accordingly, the controller 30 can monitor and receive data on path 324 and input Dn from any of the memory devices. In the example embodiment shown, the memory controller 30 receives Dn, DSI and CSI signals from the last memory device (e.g., memory device 303) through respective interconnections 317, 318 and 319. As mentioned above, the controller 30 can output data on path 325 to initiate modification (e.g., to correct errors) of data in any of the memory devices.

A number of memory devices in the daisy-chain can be virtually unlimited. In one embodiment, however, certain applications may be limited to a string of 255 memory devices. If a specific system requires more memory than 255 memory devices, the device address (=DA) byte definition in Table 2 may be expanded to two bytes for example. In such a case the total number of memory devices can be 65535=2¹⁶−1.

In one embodiment, the memory system 200 resides on a respective substrate 205 such as a printed circuit board or a multi-chip package (e.g., MCP). MCP (Multi-Chip-Package) devices can be used in the daisy-chain configuration, and if one single MCP itself contains 8 memory chips inside which are already serially interconnected, then 63 MCP devices may be the maximum number in a single channel if the current packet protocol is used.

In the example embodiment shown in FIG. 2, the controller 30 initiates a copy of data from memory core of memory device 300 to memory core of memory device 301. The block of data being copied includes 128 pages. Note that the description of copying of 128 pages is included by way of example only and that the block copies can be a single bit of data to many bits of data.

In one embodiment, the page buffers of the memory devices can store a single page of data at a time. Thus, a copy of data from memory device 300 to memory device 301 includes multiple transfers of data from the page buffer of memory device 300 to the page buffer of memory device 301.

In the context of the present example, the memory controller 30 drives the commonly connected main clock signal 304 to each of the memory devices in the daisy-chain. Each memory device can have the same tIOL (Input-to-Output Latency in clock cycles) as shown in the figure. In this example, the memory system 200 includes four series connected memory devices including memory device 300, memory device 301, memory device 302, and memory device 303 (e.g., HLNAND memory devices). However, as discussed above, the memory system 200 can include many more memory devices in the respective daisy-chain such as 255 memory devices or more.

Note that the memory system 200 according to embodiments herein can include a heterogeneous set of memory devices in the respective daisy-chain. For example, memory system 200 can comprise a daisy-chain of different types of memory devices such as DRAM, flash memory, etc. The different types of memory devices in the daisy-chain can be used for different purposes.

In yet other embodiments, the memory system 200 can be configured to include multiple daisy-chains. For example, one daisy-chain (as shown) can include a string of multiple memory devices including memory device 300, memory device 301, memory device 302 and memory device 303 as shown. Another independent daisy-chain emanating from controller 30 can include another set of memory devices. To support communications over the second daisy-chain, the controller 30 can produce a second set of control and data signals (e.g., CSO, DSO, and Qn) to carry out copy operations in the second daisy-chain.

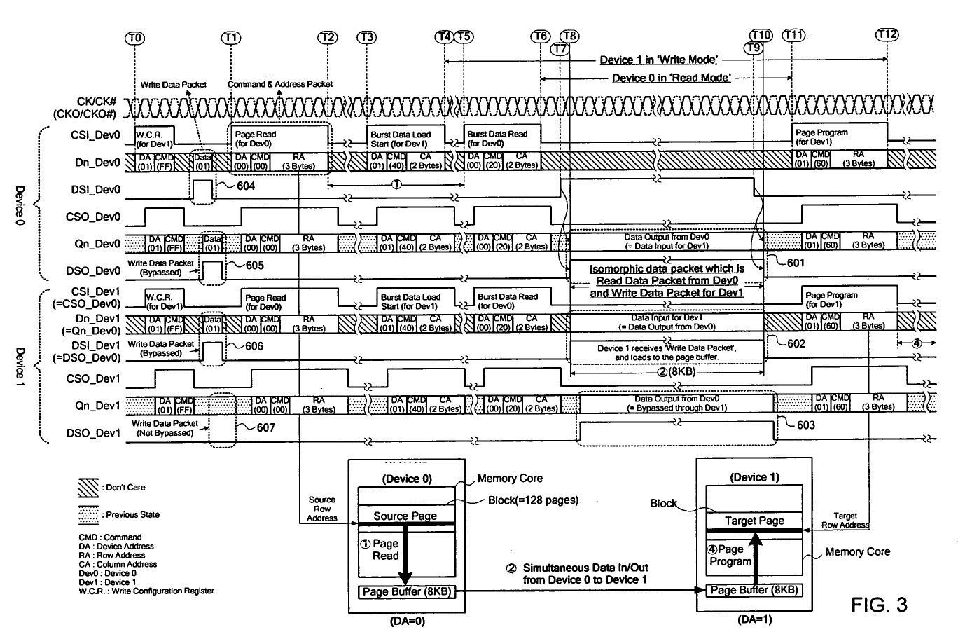

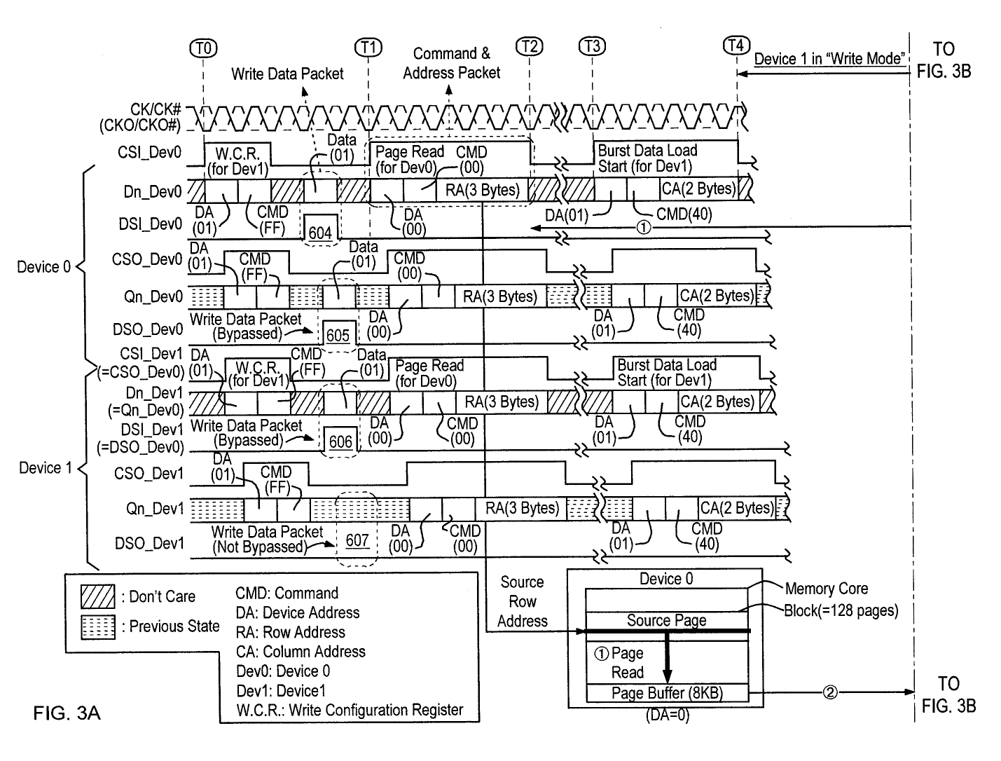

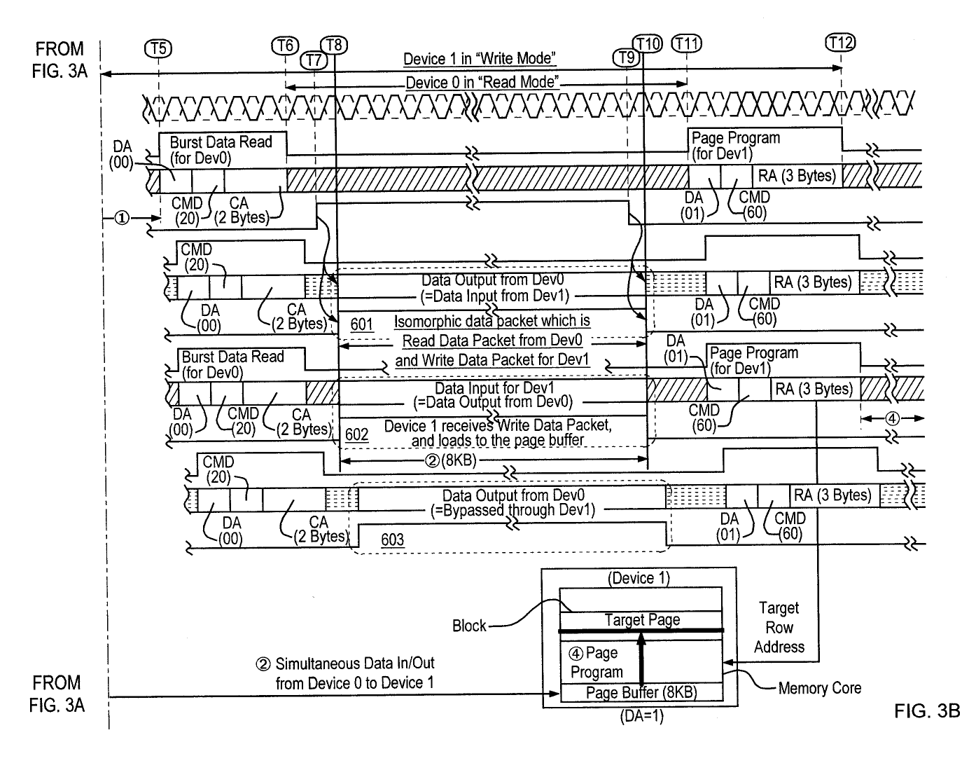

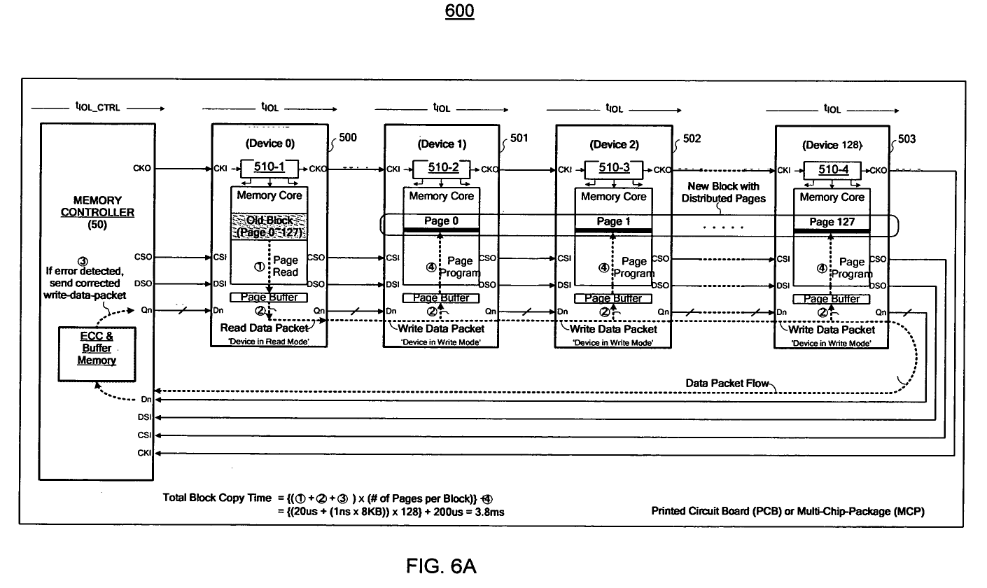

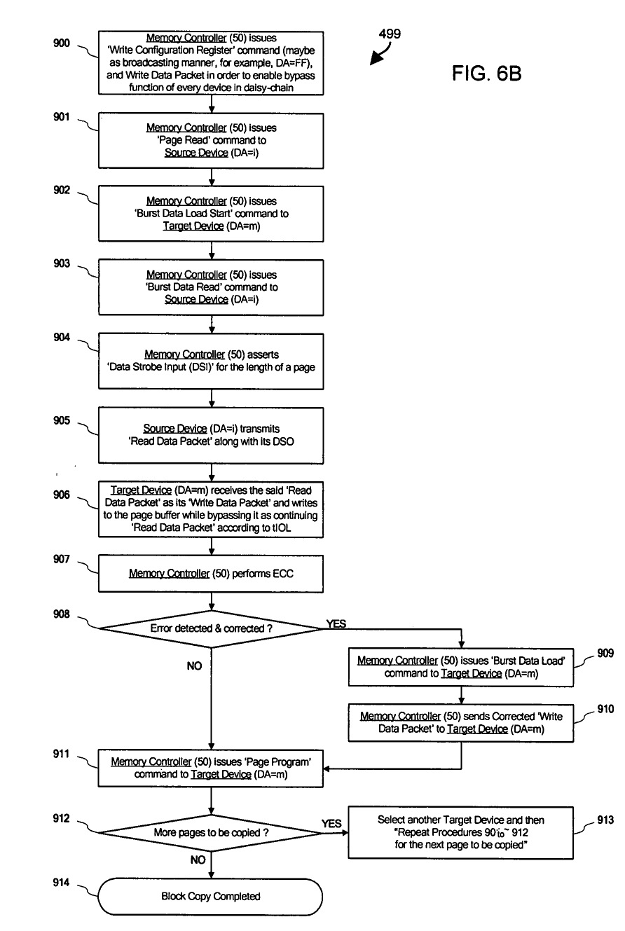

FIG. 3 is a detailed timing diagram illustrating timing associated with copying of data from a source memory device to a target memory device according to embodiments herein. As shown, at time T0, memory device 300 (e.g., device 0) receives the ‘Write Configuration Register’ command packet (01h & FFh) and ‘Write Data Packet’ (01h). As device address (DA=01h) in the command packet is not matching with the device address of memory device 300, the memory device 300 ignores the received command packet, and bypasses the command packet to the next memory device 301 through interconnections 308 and 310. A detailed timing diagram is shown in FIG. 6. The write data packet is bypassed too. Table 1 below is an example definition for the write configuration register.

TABLE 1

| Configuration | | Bit 7 | Bit 6 | Bit 5 | Bit 4 | Bit 3 | Bit 2 | Bit 1 | Bit 0 |
|---|---|---|---|---|---|---|---|---|---|
| Bypass of Write | Disable | | | | | | | | 0 |
| Data Packet | Enable | | | | | | | | 1 |
| (Default = Disable) | | | | | | | | | |

| | |
|---|---|
| RFU | All Other Combination |

In response to receiving the ‘Write Configuration Register’ (01h & FFh) command packet and ‘Write Data Packet’ (01h) 606 from controller 30 through the memory device 300, memory device 301 locally activates its bypass function to enable the pass-through mode because the received device address (DA=01h) is matching with its own device address. However ‘Write Data Packet (01h)’ 606 is not bypassed to the position 607 (e.g., on Qn output of device 1) because memory device 301 is still in a bypass disabled mode.

Device 301 can be “bypass mode” after processing “Write Data Packet” (01h) 606. Before issuing such a command, the device 301 will be in the ‘bypass disabled mode’.

At time T1, the source memory device 300 receives a ‘Page Read’ command packet (00h & 00h & RA) and starts to perform page read operation as shown. The page read operation includes retrieving data stored in memory core of memory device 300. In one embodiment, this time period to retrieve a page is 20 microseconds.

At time T3, the memory controller 30 issues a ‘Burst Data Load Start’ command packet (01h & 40h & CA) to memory device 301 in order to set memory device 301 to a ‘Write Mode’ to receive the data from memory device 300.

At time T5, memory device 300 receives the ‘Burst Data Read’ command packet (00h & 20h & CA) generated by controller 30. This command initiates a transfer of the data in the page buffer of memory device 300 on path 321 to the page buffer of memory device 301. Thus, the page read time requirement of 20 microseconds is satisfied before attempting to transfer the retrieved data to a target memory device.

A time T7 when DSI signal is asserted from the memory controller 30 to memory device 300, memory device 300 starts to output its page buffer data through the Qn pins to memory device 301. Since the DSI and Dn pins of memory device 301 are directly connected to the DSO and Qn pins of memory device 300, the target memory device 301 receives the incoming data for storage in its respective page buffer. During the transfer, isomorphic data packets 601 and 602 (e.g., page data) are transmitted from memory device 300 to memory device 301 between time T8 and time T10. The data from memory device 300 is stored in the page buffer of memory device 301.

At time T11, the memory controller 30 communicates a ‘Page Program’ command packet (01h & 60h & RA) to memory device 301. This initiates storage of the received data to be written from the page buffer to core storage in memory device 301.

The above description of timing diagram of FIG. 3 illustrates a transfer of a single page of data from memory device 300 to memory device 301. This process can be repeated for each of multiple other pages associated with the block copy operation.

After completing a whole block copy from a source memory device to a target memory device, the controller 30 can issue another ‘Write Configuration Register’ command in order to reset the bypass function to a disabled state.

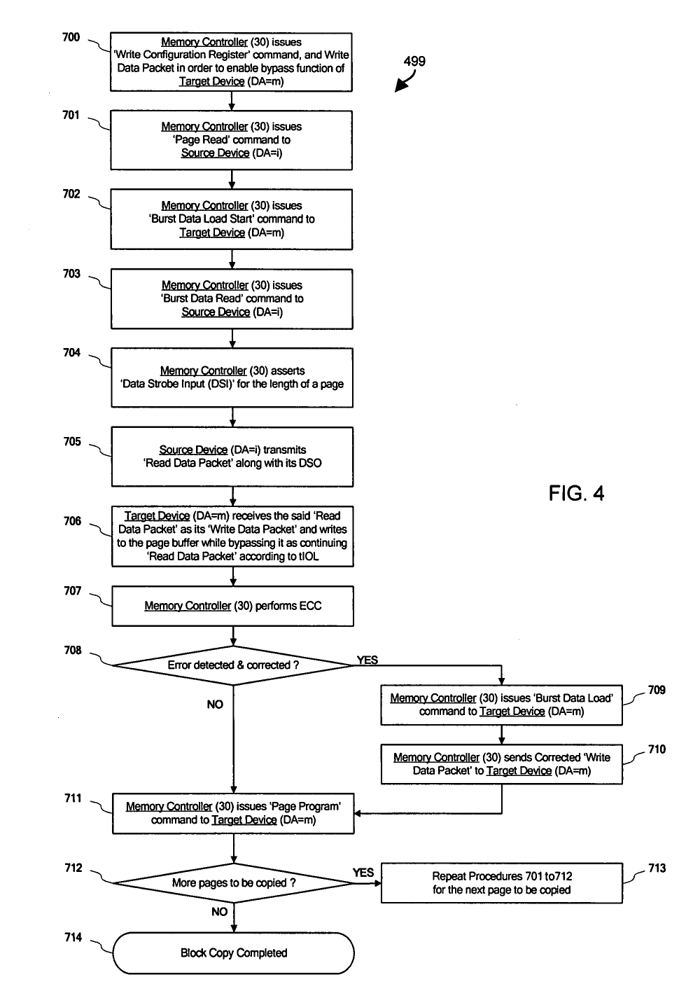

FIG. 4 is an example flowchart 499 illustrating a block copy method according to embodiments herein. In general, as discussed above, flowchart 499 illustrates an example block copy of data from a source memory device 300 to a target memory device 301 as depicted in FIG. 2. As discussed below, to carry the copy operation, the controller 30 communicates over the daisy-chain link (e.g., control link and data link) to configure the memory devices and initiate the block copy. Note that all values associated with the following commands are listed as hex values.

In step 700, for each target address, the controller 30 issues a ‘Write Configuration Register’ command with corresponding values (DA & FFh) and ‘Write Data Packet’ command with corresponding value 01h in order to enable the bypass function of the target memory device 301. The bypass function (e.g., pass-through mode) can be programmed in accordance with the values in Table 1. As discussed above, the bypass mode (e.g., signal pass-through mode) can be disabled for power saving purposes. However, in this block copy example, the controller 30 sets the target memory device 301 to the bypass enabled mode (e.g., pass through enabled) in order to transmit the ‘Write Data Packet’ to and through the next memory devices in the daisy-chain so that eventually the said ‘Write Data Packet’ (which is originally ‘Read Data Packet’ from the source memory device 300) will be passed through the daisy-chain to the memory controller 30. Note that if there are several target devices, the controller 30 will issue commands to the several target devices to initiate the block copy.

In step 701, the memory controller 30 generates a ‘Page Read’ command packet with corresponding values (DA & 00h) to the source memory device 300. Based on receipt of such a command, the source memory device 300 initiates a transfer of a page data from a specified location of its memory core to its corresponding page buffer. In one embodiment, this operation may take 20 microseconds to complete the transfer.

In step 702, while (or after) the source device 300 performs a page read operation, the memory controller 30 issues a ‘Burst Data Load Start’ command packet with corresponding values (DA & 40h) to the target memory device 301 so that the target memory device 301 enters into a ‘Write Mode’ and is at least prepared to receive a ‘Write Data Packet’ (e.g., data from the source memory device 300).

In one embodiment, the memory controller 30 simply waits 20 microseconds (or some other specified amount of time) to be assured that the page read operation has been completed and a data transfer is now possible.

In step 703, after the page read operation is complete in the source memory device 300, the memory controller 30 issues a ‘Burst Data Read’ command packet with corresponding values (DA & 20h) to the first memory device 300. Based on receipt of this command, the first memory device 300 enters in to the ‘Read Mode’ and is prepared to receive a DSI assertion, which is signaling to output the data in the page buffer of memory device 300.

In step 704, the memory controller 30 then asserts DSI for the length (e.g., 8 kilobytes) of a page being transferred from memory device 300 to memory device 301. Note again that the length of a data transfer can be any number of bits of information such as a single bit to multiple bytes.

In step 705, based on assertion or activation of the DSI signal, memory device 300 initiates transmission of a ‘Read Data Packet’ to transfer the data in page buffer of memory device 300 to the page buffer of target memory device 301.

In step 706, target memory device 301 receives the ‘Read Data Packet’ as a ‘Write Data Packet’ because the target memory device 301 was set to a ‘Write Mode’ and was expecting the ‘Write Data Packet’ according to its DSI input signal. Thus, based on the above signaling, the page of data in memory device 300 is automatically transferred from source memory device 300 to the second memory device 301 in a single burst data transfer period.

In accordance with one embodiment, the transfer of data in this way can be defined as an isomorphic data packet or isomorphic data transfer because of the two different types of data packets are actually transmitted in the same data packet flow.

In a similar vein as discussed above, the flow of data as discussed in this example is beneficial because it eliminates the controller 30 from having to retrieve data from a source memory device and store the retrieved data in the target memory device. An example of time saving is more particularly shown in FIG. 2. For example, a total block copy time can be 39 milliseconds according to embodiments herein, whereas conventional techniques may require an additional 10 milliseconds to transfer the data to the controller and then from the controller to the target memory device.

Note that an actual transfer time (e.g., 39 millisecond copy time) to copy data from one memory device to another will vary depending on the speed of the memory devices employed in the respective memory system. Thus, the example transfer speeds mentioned above have been mentioned only for illustrative purposes as the time to complete a data transfer can vary depending on memory speed as well as additional factors recognized by those skilled in the art.

In step 707 of FIG. 4, the memory controller 30 applies an optional ECC (Error-Correction-Code) operation to the data passing on the daisy-chain from memory device 300 to the target memory device 301 in order to check if there were any bit-errors that occurred while reading out a page. Recall that the controller 30 uses configuration commands to put the memory devices in a pass-through mode in which the data copied from the source device to the target device passes along the daisy-chain to the controller 102 for checking.

In step 708, the controller 30 checks whether there is an error in the data transferred from the source memory device to the target memory device. If the ECC operation detects presence of an error in the transferred data, flow continues at step 709.

In step 709, the controller 30 configures the target memory device 301 to receive data from the controller 30.

In step 710, the controller 30 sends the corrected data (e.g., from the ECC function in controller 30) over the daisy-chain link to the page buffer of the target memory device 301. Accordingly, the controller 30 modifies the data in the page buffer.

In step 708, after completing the ECC operation and assuming that there initially were or no longer are errors in the data stored in the page buffer of the target memory device 301, flow continues at step 711.

In step 711, the memory controller 30 issues ‘Page Program’ command packet (DA & 60h) to the target memory device 301. In response to receiving the command, memory device 301 starts to write the data in the page buffer to the selected memory page location.

In step 712 the controller 30 checks whether there are additional pages of data to be copied from the source memory device to the target memory device. If so, the memory controller 30 executes step 713, which entails repeating the steps 701-712 for each additional page to be copied. The number of pages to be copied can be any value. In this example, there are 128 pages of data copied from memory device 300 to memory device 301.

If the controller 30 detects that there are no additional pages to be copied, the controller 30 proceeds to step 714.

Step 714 concludes the example block copy operation. In one embodiment, the controller 102 initiates one or more writes to respective configuration registers associated with the memory devices upon completion to place the memory devices in an idle mode.

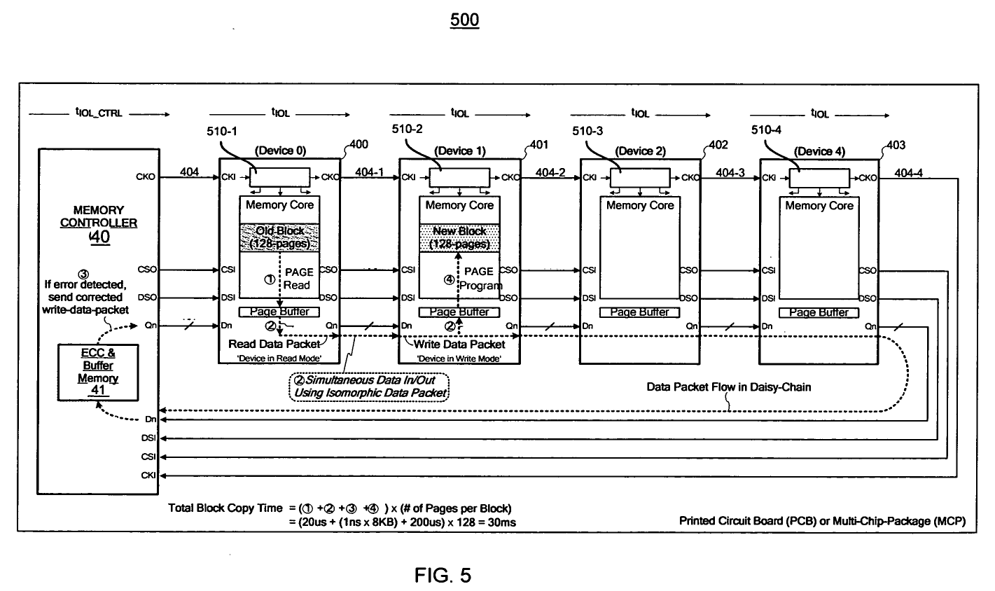

FIG. 5 is an example diagram of a memory system in which the clock outputted by the controller 40 is connected in a serial daisy-chain manner through the string of memory devices according to second embodiments herein. For example, the controller 40 drives memory device 400 with a respective clock signal, memory device 401 outputs a clock signal to memory device 401, and so on.

Each memory device in the daisy-chain can include a clock synchronizer circuit to adjust the received clock signal. In the example embodiment shown, memory device 400 includes synchronizer circuit 510-1, memory device 401 includes synchronizer circuit 510-2, memory device 402 includes synchronizer circuit 510-3, and memory device 403 includes synchronizer circuit 510-3. Note that functionality provide by the clock synchronizer circuits 510 can be provided by PLL (Phase Locked Loop) devices, DLL (Delay Locked Loop) devices, etc. or other suitable circuits. Use of the clock synchronizers decreases access times. More details associated with the clock synchronizers (e.g., externally adjusted PLLs, DLLs, etc.) are discussed in related U.S. Provisional Patent Application Ser. No. 60/894,246 entitled “APPARATUS AND METHOD FOR SYNCHRONIZING CLOCK IN SERIAL INTERCONNECTION CONFIGURATION OF SEMICONDUCTOR DEVICES,” (Attorney Docket No. 1251-01US-0PR-00), filed on Mar. 12, 2007, the entire teachings of which are incorporated herein by this reference.

In this example embodiment, the string of memory devices including memory device 400, memory device 401, memory device 402, memory device 403 and the memory controller 40 are connected in real point-to-point serial manner between respective devices (CKI, CKO). The point to multi-point connections from the controller 102 (as in FIG. 2) to each memory device may cause an accumulated phase error problem if the operating frequency is too high (e.g., several GHz). Use of special synchronization circuits (e.g., synchronizer circuits 510-1, 510-2, 510-3, and 510-4) (as in FIG. 5) built in each memory devices compensates for this problem.

General operation of the memory system 500 as shown in FIG. 5 is similar to that in FIG. 2. However, as mentioned above, each of the memory devices in memory system 500 employ an externally adjusted PLL block so that the burst data transfer time is much faster than that provided by the memory system 200 in FIG. 2. For example, the calculated block copy time for memory system 500 would be only 29 milliseconds as compared to 39 milliseconds for the memory system 200 shown in FIG. 2.

In the context of the present example of memory system 500, main controller 40 outputs clock signal CKO on interconnection 404 to CKI input of memory device 400. Memory device 400 includes an externally adjusted phase lock loop module to adjust the received clock and produce an outputted clock signal CKO on interconnection 404-1 to memory device 401. Memory device 401 includes an externally adjusted phase lock loop module to adjust the received clock signal and produce an outputted clock signal CKO on interconnection 404-2 to memory device 402. Memory device 402 includes an externally adjusted phase lock loop module to adjust the received clock and produce an outputted clock signal CKO on interconnection 404-3 to memory device 403. Memory device 403 includes an externally adjusted phase lock loop module to adjust the received clock and produce an outputted clock signal CKO on interconnection 404-4 to controller 40.

FIG. 6A is a diagram of a memory system 600 supporting distribution of data from a source memory device to each of multiple target memory devices according to embodiments herein.

In this block copy method, the target includes multiple memory devices. Based on commands issued by the controller 50 to the memory devices in a same manner as discussed above, a first page of information from the source memory device is copied to a first target memory device, a second page of information from the source memory device is copied to a second target memory device, a third page of information from the source memory device is copied to a third target memory device, and so on. To carry out the distributed block copy, the controller 50 communicates with each of the memory devices to precisely orchestrate distribution of the portions of data to specific locations in the different memory devices. Accordingly, a block copy can include transferring data from a source memory device to each of multiple target memory devices in the daisy-chain.

In one embodiment, the pages in a block are consecutive pages of information. The controller 50 initiates copying a first page (e.g., page 0) of the block of data to memory device 501; a second page (e.g., page 1) of the block of data to memory device 502, and so on.

According to such embodiments, the time required to copy a block from one memory device to multiple memory devices can be substantially less than the time required to copy a block of data from a source memory device to a single target memory device. For example, it is possible that the controller 50 can complete a distributed block copy operation in 3.8 milliseconds, which is substantially less the time required to complete a block copy as shown in FIGS. 2 and 5.

FIG. 6B is an example flowchart 699 illustrating copying of data from a single memory device to multiple memory devices according to embodiments herein.

In step 900, for a first target address such as target memory device 501, the controller 50 issues a ‘Write Configuration Register’ command and ‘Write Data Packet’ command in order to enable the bypass function of the given target device. This may be achieved via sending a broadcast command.

In step 901, the memory controller 50 issues a ‘Page Read’ command packet to a given source memory device (e.g., memory device 500).

In step 902, the memory controller 50 issues a ‘Burst Data Load Start’ command packet to the target memory device.

In step 903, the memory controller 50 issues a ‘Burst Data Read’ command packet to the source device (e.g., memory device 500).

In step 904, the memory controller 50 then asserts DSI for the length (e.g., 8 kilobytes) of a page being transferred from memory device 500 to the given target device. Note again that the length of a data transfer can be any number of bits of information such as a single bit to multiple bytes.

In step 905, based on assertion or activation of the DSI signal, memory device 500 initiates transmission of a ‘Read Data Packet’ to transfer the data in page buffer of memory device 500 to the page buffer of target memory device (e.g., memory device 501).

In step 906, the target memory device receives the ‘Read Data Packet’ as a ‘Write Data Packet’ and writes to the page buffer while bypassing it as continuing ‘Read Data Packet.’

In step 907, the memory controller 50 applies an ECC (Error-Correction-Code) operation to the data passing on the daisy-chain from memory device 500 to the target memory device.

In step 908, the controller 50 checks whether there is an error in the data transferred from the source memory device to the target memory device. If the ECC operation detects presence of an error in the transferred data, flow continues at step 709.

In step 909, the controller 50 configures the target memory device to receive data from the controller 50 by issuing a Burst Data Load command to the target device.

In step 910, the controller 50 sends the corrected data (e.g., from the ECC function in controller 50) over the daisy-chain link to the page buffer of the target memory device. Accordingly, the controller 50 modifies the data in the page buffer.

In step 908, after completing the ECC operation and assuming that there initially were or no longer are errors in the data stored in the page buffer of the target memory device, flow continues at step 911.

In step 911, the memory controller 50 issues a ‘Page Program’ command packet to the target memory device. In response to receiving the command, the target memory device starts to write the data in the page buffer to the selected memory page location.

In step 912, the controller 50 checks whether there are additional pages of data to be copied from the source memory device to other target memory device. If so, the memory controller 50 executes step 913, which entails repeating the steps 901-912 for each additional page to be copied. In this way, the controller 50 can initiate successive copying of pages from the source memory device to the successive target memory devices. The number of pages to be copied can be any value. In this example, there are 128 pages of data copied from memory device 500 to the 128 target memory devices.

If the controller 50 detects that there are no additional pages to be copied, the controller 50 proceeds to step 714.

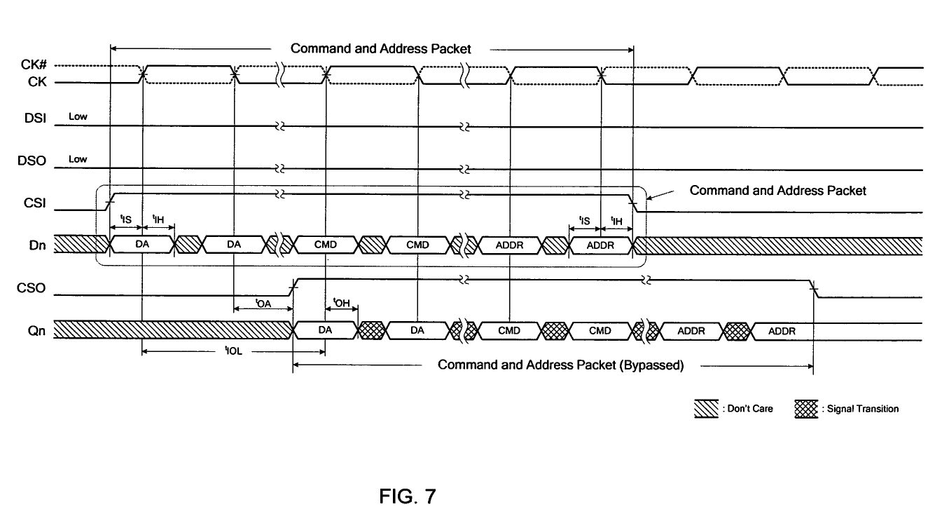

FIG. 7 is an example timing illustrating a zoomed in view of signals in a respective memory device (e.g., clocks, DSI, DSO, CSI, CSO, Dn and Qn) during issuance of a command and address packet according to embodiments herein. Note that the “Command and Address Packet” includes device address (DA), command (CMD), and/or address (ADDR) information. As previously discussed, the memory devices decode this information to identify whether the command is to be executed by the receiving memory device. Table 2 below is an example of a bit definition associated with the command and address packets:

TABLE 2
Example of Command and Address Packet Sequences

| Operation | 1^{st} Byte | 2^{nd} Byte | 3^{rd} Byte | 4^{th} Byte | 5^{th} Byte |
|---|---|---|---|---|---|
| Page Read | DA | 00h | RA | RA | RA |
| Page Read for Copy | DA | 10h | RA | RA | RA |
| Burst Data Read | DA | 20h | CA | CA | — |
| Burst Data Load Start | DA | 40h | CA | CA | — |
| Burst Data Load | DA | 50h | CA | CA | — |
| Page Program | DA | 60h | RA | RA | RA |
| Block Erase Address | DA | 80h | RA | RA | RA |
| Input | | | | | |
| Page-pair Erase Address | DA | 90h | RA | RA | RA |
| Input | | | | | |
| Erase | DA | A0h | — | — | — |
| Operation Abort | DA | C0h | — | — | — |
| Read Status Register | DA | F0h | — | — | — |
| Read Device Information | DA | F4h | — | — | — |
| Register | | | | | |
| Read Configuration | DA | F7h | — | — | — |
| Register | | | | | |
| Write Configuration | DA | FFh | — | — | — |
| Register | | | | | |

(* DA = Device Address, RA = Row Address, CA = Column Address)

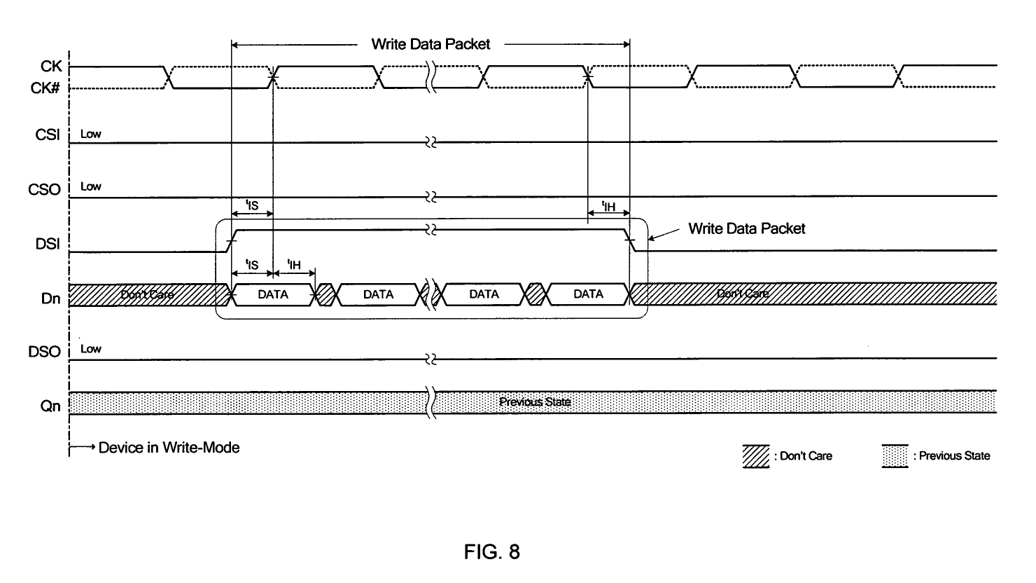

FIG. 8 is an example timing diagram illustrating a zoomed in view of signals in a memory device (e.g., clocks, DSI, DSO, CSI, CSO, Dn and Qn) during issuance of a write data packet according to embodiments herein. Note that the respective memory device in this example is set to a non-pass-though mode (e.g., bypass mode disabled) for power conservation. Thus, the data packet does not pass through on the daisy-chained data link.

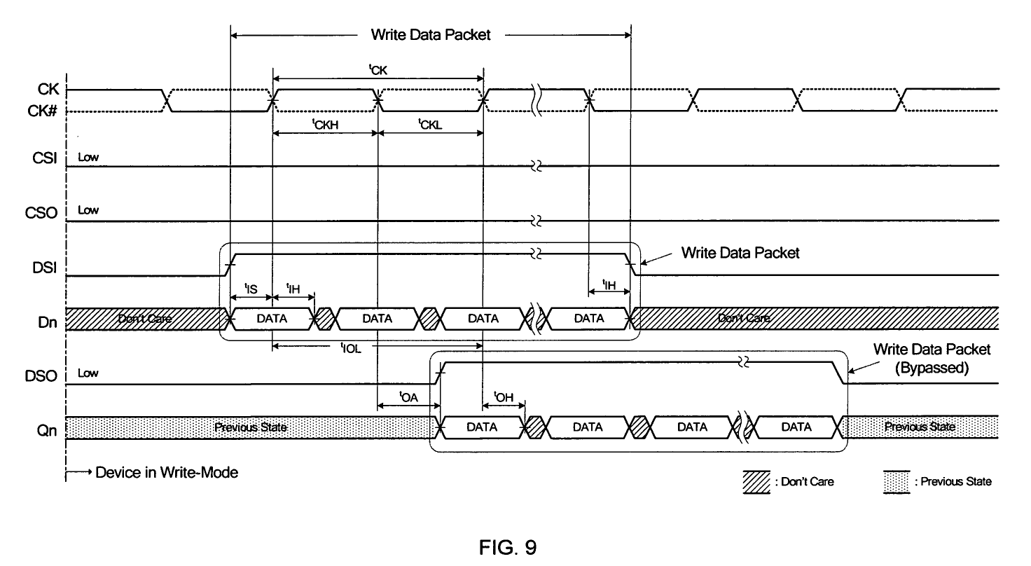

FIG. 9 is an example timing diagram illustrating a zoomed in view of signals in a memory device (e.g., clock, DSI, DSO, CSI, CSO, Dn and Qn) during issuance of a write data packet according to embodiments herein. Note that the respective memory device is set to a pass-though mode (e.g., bypass mode enabled) so that the data packet received by the respective memory device “passes” down the data link to a destination such as a successive memory device or controller. Thus, the data packet does get down through on the daisy-chained data link (at least for the respective memory device).

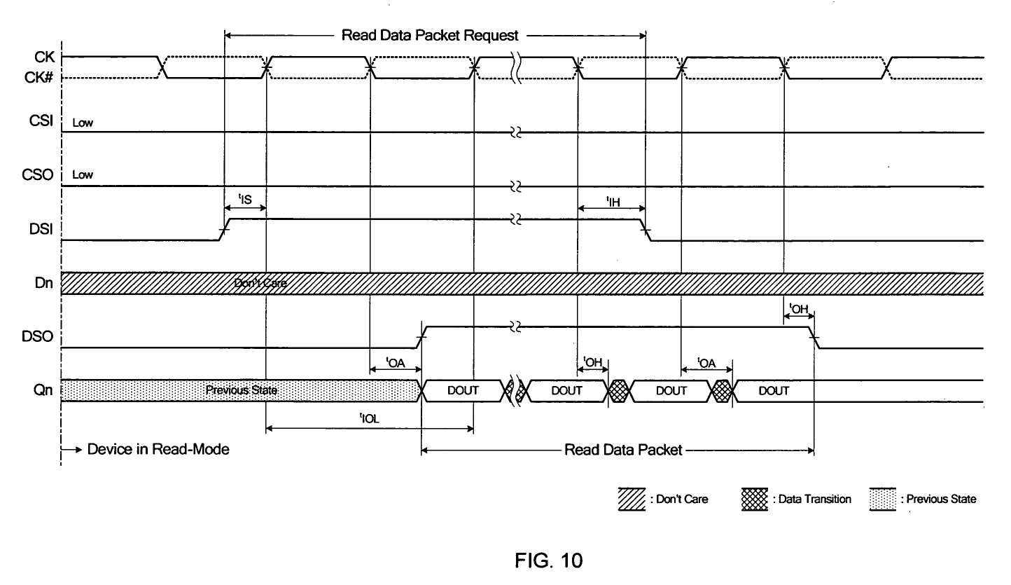

FIG. 10 is an example timing diagram illustrating a zoomed in view of signals in a memory device (e.g., clock, DSI, DSO, CSI, CSO, Dn and Qn) during issuance of a read data request according to embodiments herein. As shown, when the respective memory device is placed in the read mode via DSI, the memory device initiates outputting of data to a successive memory device.

Note that additional information associated with the discussion of FIGS. 7-10 above can be found in related United States Utility patent application Ser. No. 11/779,587 entitled “Memory with Data Control,” [Attorney Docket No. MOS07-02(1255-01US-000-45)], filed on Jul. 18, 2007, the entire teachings of which are incorporated herein by this reference.

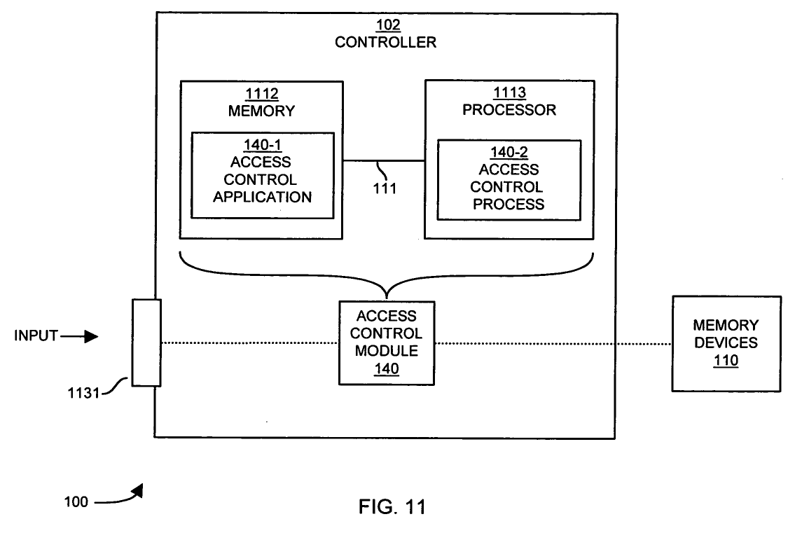

FIG. 11 is a block diagram of an example architecture of a respective controller 102 for implementing access control module 140 (e.g., access control application 140-1 and/or access control process 140-2) according to embodiments herein. In one embodiment, access control application 140-1 can be a sequence of instructions executed by the controller 102 to carry out copy operations as described herein. In one embodiment, access control process 140-2 represents the method and/or functionality provided by controller 102 as a result of executing the access control application 140-1.

Controller 102 can be a computerized device such as a digital signal processor, computer, etc. that executes instructions to carry control operations as described herein.

Note that the following discussion provides a basic embodiment indicating how to carry out functionality associated with the access control module 140. It should be noted that the actual configuration for carrying out the access control module 140 may vary depending on a respective application. For example, the controller 102 and corresponding functionality can be implemented via hardware alone, as software, or as a combination of hardware and software.

In the example embodiment shown, controller 102 of the present example includes an interconnect 111 that couples a memory system 1112 to a processor 1113. Communications interface 1131 enables controller 102 to receive input such as requests to perform block copy operations with respect to memory devices 110.

As shown, memory system 1112 is encoded with access control application 140-1 that supports access control as discussed above and as discussed further below. Access control application 140-1 can be embodied as software code such as data and/or logic instructions (e.g., code stored in the memory or on another computer readable medium such as a disk) that supports processing functionality according to different embodiments described herein. During operation of one embodiment, processor 1113 accesses memory system 1112 via the use of interconnect 111 in order to launch, run, execute, interpret or otherwise perform the logic instructions of the access control application 140-1. Execution of the access control application 140-1 produces processing functionality in access control process 140-2. In other words, the access control process 140-2 represents one or more portions of the access control module 140 performing within or upon the processor 1113 in the controller 102.

It should be noted that, in addition to the access control process 140-2 that carries out method operations as discussed herein, other embodiments herein include the access control application 140-1 itself (i.e., the un-executed or non-performing logic instructions and/or data). The access control application 140-1 may be stored on a computer readable medium (e.g., a repository) such as a floppy disk, hard disk or in an optical medium. According to other embodiments, the access control application 140-1 can also be stored in a memory type system such as in firmware, read only memory (ROM), or, as in this example, as executable code within the memory system 1112 (e.g., within Random Access Memory or RAM).

In addition to these embodiments, it should also be noted that other embodiments herein include the execution of the access control application 140-1 in processor 1113 as the access control process 140-2. Thus, those skilled in the art will understand that the controller 102 can include other processes and/or software and hardware components, such as an operating system that controls allocation and use of hardware resources.

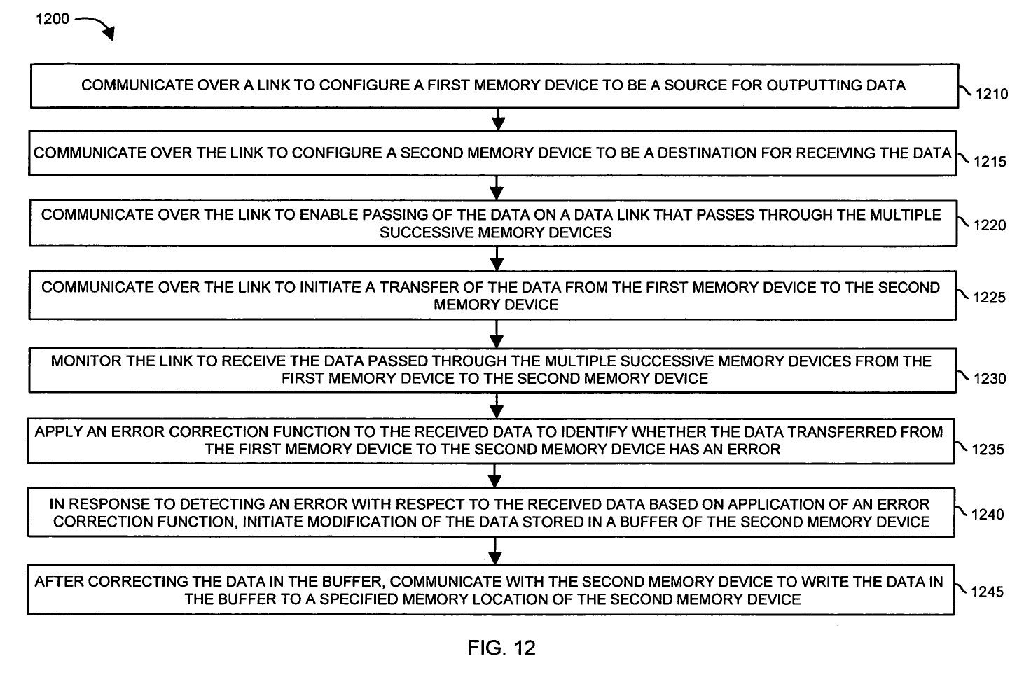

Functionality supported by access control module 140 will now be discussed via flowcharts in FIG. 12.

FIG. 12 is a diagram of an example flowchart 1200 illustrating a block copy operation according to embodiments herein. In addition to referencing the steps of flowchart 1200 in FIG. 12, reference will be made with respect to the memory system 100 in FIG. 1.

In step 1210, the controller 102 communicates over a daisy-chain control link 150 to configure a first memory device (e.g., memory device 110-1 in FIG. 1B) of multiple daisy-chained memory devices to be a source for outputting data stored in the first memory device.

As an alternative to the present example, note that controller 102 can choose memory device 110-M to be the source memory device and memory device 110-1 to be the target memory device. In such an embodiment, the data would be transferred through controller 102 to the target.

Referring again to the present example in which memory device 110-1 is the resource and memory device 110-M is the target, in step 1215, the controller 102 communicates over the daisy-chain control link 150 to configure a second memory device (e.g., memory device 110-M in FIG. 1B) of the multiple memory devices 110 to be a destination for receiving the data.

In step 1220, the controller 102 communicates over the control link 150 to enable passing of the data on a data link 160 through the multiple successive memory devices 116 in a daisy-chain manner. For example, the controller 102 sets the intermediate memory devices 110 between the source memory device and the target memory device to the pass-through mode so that the data from memory device 110-1 can be transmitted on data link 160 to the target device. Memory device 110-M also can be set to the pass-through mode so that the controller 102 can monitor the data transferred from the source memory device to the target memory device.

In step 1225, the controller 102 communicates over the daisy-chain control link 150 to initiate a transfer of the data from the source memory device 110-1 to the target memory device 110-M.

In step 1230, the controller 102 monitors the data link to receive the data passed through the multiple successive memory devices 110 from the source memory device 110-1 to the target memory device 110-M.

In step 1235, the controller 102 applies an error correction function to the received data to identify whether the data transferred from the first memory device to the second memory device has an associated error.

In step 1240, in response to detecting an error with respect to the received data based on application of the error correction function, the controller 102 initiates modification of the data in the buffer of the second memory device prior to writing of the data to core memory.

In step 1245, after correcting the data in the buffer, the controller 102 communicates with the target memory device 110-M to write the data in the respective page buffer to a specified memory location of the core memory associated with the target memory device 110-M.

Certain adaptations and modifications of the described embodiments can be made. Therefore, the above discussed embodiments are considered to be illustrative and not restrictive.

What is claimed is:

1. A memory system comprising:
a plurality of memory devices including a first memory device and a second memory device;
a controller, the controller and the plurality of memory devices being connected in series to permit propagation of data through the memory devices, and the controller for:
configuring the first memory device to be a source for outputting data stored in the first memory device;
configuring the second memory device to be a destination for receiving the data; and
causing to be initiated, a transfer of the data from the first memory device to the second memory device.

2. A memory system as in claim 1, wherein the controller is configured to transmit a command for receipt at an input of the first memory device, the first memory device configured to output the command to an input of the second memory device.

3. A memory system as in claim 1, wherein the controller is configured to output a first setup instruction on a control link, the first setup instruction addressed to the first memory device to configure the first memory device to read the data from a memory location of the first memory device as specified by the controller; and
wherein the controller is configured to output a second setup instruction on the control link through the first memory device to the second memory device, the second setup instruction addressed to the second memory device to configure the second memory device for performing a write to a memory location in the second memory device as specified by the controller.

4. A memory system as in claim 1, further comprising a link that enables transmission of the data from the first memory device, through an intermediary memory device between the first memory device and the second memory device, to the second memory device.

5. A memory system as in claim 1, wherein the controller is configured to communicate a command over a link to initiate writing of the data to a memory location associated with the second memory device after the transfer of the data from the first memory device to the second memory device.

6. A memory system as in claim 1 further comprising:
a data link through the plurality of memory devices; and
wherein the controller is configured to initiate communication over a control link to enable passing of the data on the data link from the first memory device through the second memory device back to the controller; and
wherein the controller is configured to monitor and receive the data on the data link as the data is transferred from the first memory device to the second memory device.

7. A memory system as in claim 6 further comprising:
an error detector circuit configured to apply an error correction function to the data received at the controller, the error correction function configured to identify whether the data transferred from the from the first memory device to the second memory device has an error.

8. A memory system as in claim 7 further comprising:
a buffer in the second memory device to temporarily store the data prior to the data being stored in a memory location associated with the second memory device; and
wherein the error detection circuit is configured to communicate over the control link to modify the data in the buffer in response to detecting the error prior to writing the data in the buffer to the memory location associated with the second memory device.

9. A memory system as in claim 1 further comprising:
a data through the plurality of memory devices;
wherein the plurality of memory devices includes a third memory device;
wherein the third memory device is configurable to be another destination for receiving the data;
wherein the second memory device is configured to store the data received of the data link as well as pass the received data on the data link to the third memory device; and
wherein the controller causes to be initiated, a transfer of the data on the data link from the first memory device to the third memory device at a same time as the transfer of the data from the first memory device to the second memory device.

10. A memory system as in claim 1 further comprising:
a ring-connection data link through the plurality of memory devices;
wherein the plurality of memory devices includes a third memory device;
wherein the controller is configured to communicate over a control link to initiate passing of a first portion of the data on the data link from the first memory device for storage of the first portion of the data in the second memory device; and
wherein the controller is configured to communicate over the control link to initiate passing of a second portion of the data on the data link from the second memory device for storage of the second portion of the data in the third memory device.

11. A method comprising:
communicating over a ring-connection link that passes through a plurality of memory devices to configure a first memory device of the plurality of memory devices to be a source for outputting data stored in the first memory device;
communicating over the ring-connection link to configure a second memory device of the plurality of memory devices to be a destination for receiving the data; and
communicating over the ring-connection link to initiate a transfer of the data from the first memory device to the second memory device.

12. A method as in claim 11, wherein communicating over the ring-connection link to configure the first memory device includes transmitting a command to an input of the first memory device, the first memory device in turn outputting the command to an input of the second memory device of the ring-connection.

13. A method as in claim 11, wherein communicating over the ring-connection link to configure the first memory device includes outputting at least one setup instruction, which is addressed to the first memory device, onto the ring-connection link to configure the first memory device to read the data from a memory location in the first memory device; and
wherein communicating over the ring-connection link to configure the second memory device includes outputting at least one setup instruction, which is addressed to the second memory device, onto the ring-connection link to configure the second memory device for performing a write to a memory location in the second memory device.

14. A method as in claim 11, wherein communicating over the ring-connection link to initiate the transfer includes communicating over the ring connection link to initiate transmission of the data on a data link that passes through the plurality of memory devices from the first memory device, through an intermediary memory device between the first memory device and the second memory device, to the second memory device.

15. A method as in claim 11, wherein communicating over the ring-connection control link to initiate the transfer of the data from the first memory device to the second memory device includes:
communicating over the ring-connection link to initiate writing of the data to a memory location associated with the second memory device after the transfer of the data from the first memory device to the second memory device.

16. A method as in claim 11 further comprising:
initiating communication over the ring-connection link to enable passing of the data on a data link that passes through the plurality of memory devices; and
monitoring the data link to receive the data passed through the plurality of memory devices.

17. A method as in claim 16 further comprising:
applying an error correction function to the received data to identify whether the data transferred from the first memory device to the second memory device has an error.

18. A method as in claim 17, wherein communicating over the ring-connection link to initiate the transfer of the data causes the data to be transferred from the first memory device to a buffer associated with the second memory device, the method further comprising:
in response to detecting the error with respect to the received data based on application of the error correction function, initiating modification of the data in the buffer prior to writing the data in the buffer to a memory location associated with the second memory device.

19. A method as in claim 11 further comprising:
communicating over the ring-connection link to configure a third memory device of the plurality of memory devices to be another destination for receiving the data from the first memory device; and
wherein communicating over the ring-connection link to initiate the transfer includes initiating transmission of the data from the first memory device to the third memory device.

20. A method as in claim 11 further comprising:
communicating over the ring-connection link to configure a third memory device of the plurality of memory devices to be another destination for receiving the data from the first memory device; and
wherein communicating over the control link to initiate the transfer of the data includes:
communicating over the ring-connection link to initiate storage of a first portion of the data from the first memory device to a memory location in the second memory device; and
communicating over the ring-connection link to initiate storage of a second portion of the data from the first memory device to a memory location in the third memory device.

21. A memory device comprising:
memory to store data;
an input for receiving data from an upstream memory device;
an output for transmitting data to a downstream memory device; and
circuitry between the input and the output, the circuitry configured to receive configuration commands from a remote source and, based on selection of a corresponding mode by the remote source, retrieve the data stored in the memory for transmission on the output to the downstream memory device.

22. A memory device as in claim 21, wherein the circuitry is configured to, based on selection of a corresponding mode, monitor the input and receive data from the upstream memory device for transmission on the output to the downstream memory device.

23. A memory device as in claim 21, wherein the input is a first input and the output is a first output, the memory device further comprising:
a second input configured to receive commands from the upstream memory device;
a second output configured to convey the received commands to the downstream memory device; and
decoding circuitry between the second input and the second output, the circuitry configured to convey the received commands from the second input to the second output and identify which of the received commands are addressed to the memory device for execution.

24. A memory device comprising:
memory to store data;
a buffer;
an input for receiving data from an upstream memory device;
an output for transmitting data to a downstream memory device; and
circuitry between the input and the output, the circuitry configured to receive configuration commands from a remote source and, based on selection of a corresponding mode by the remote source, monitor the input and receive data from the upstream memory device for storage in the buffer.

25. A computer-readable medium having instructions stored thereon, the computer-readable medium including:
instructions for communicating over a ring-connection link that passes through a plurality of memory devices to configure a first memory device of the plurality of memory devices to be a source for outputting data stored in the first memory device;
instructions for communicating over the link to configure a second memory device of the plurality of memory devices to be a destination for receiving the data; and
instructions for communicating over the ring-connection control link to initiate a transfer of the data from the first memory device to the second memory device.
